(19) United States
(12) Patent Application Publication
(10) Pub. No.: US 2025/0032990 A1
(43) Pub. Date: Jan. 30, 2025

(54) MEMBRANE CONTACTOR FOR ENERGY-EFFICIENT CO2 CAPTURE FROM POINT SOURCES WITH PHYSICAL SOLVENTS

(71) Applicant: UT-Battelle, LLC, Oak Ridge, TN (US)

(72) Inventors: Syed Z. Islam, Oak Ridge, TN (US); Ramesh R. Bhave, Oak Ridge, TN (US)

(21) Appl. No.: 18/785,093

(22) Filed: Jul. 26, 2024

Related U.S. Application Data
(60) Provisional application No. 63/528,927, filed on Jul. 26, 2023.

(51) Int. Cl. B01D 63/02; B01D 69/08

(52) U.S. Cl. CPC B01D 63/02; B01D 69/081; B01D 2257/504; B01D 2325/02833; B01D 2325/38

(57) ABSTRACT

An improved method for CO₂ separations using a physical solvent is provided. The method includes: (a) contacting the lumen side or the shell side of a plurality of porous hollow fibers with a CO₂-containing gas from a point source; (b) contacting the other of the lumen side or the shell side of the plurality of porous hollow fibers with a liquid phase, the liquid phase including a physical solvent for physisorption of CO₂ into the liquid phase; (c) desorbing the CO₂ from the liquid phase by reducing the pressure of the liquid phase; and (d) recirculating the liquid phase to the plurality of porous hollow fibers. As discussed herein, the improved method provides a modular, scalable process to facilitate gas-liquid contact for CO₂ separations. In addition, the improved method offers significant advantages over existing ionic liquid and amine-based technologies in terms of cost-effectiveness, energy efficiency, process scalability, and environmental stability.

### CROSS-REFERENCE TO RELATED APPLICATIONS

This application claims the benefit of U.S. Provisional Application 63/528,927, filed Jul. 26, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

The contribution of greenhouse gases to climate change has driven intense interest in the separation of CO₂ from wet flue gas streams. Wet flue gas streams include exhaust gases emitted from combustion processes and contain a significant amount of water vapor. Absorption of CO₂ in solvents is one useful approach to this separation. The ideal characteristics of a solvent for this separation include a large CO₂ absorption capacity, strong selectivity over other gases, rapid absorption and desorption kinetics, minimal solvent loss during regeneration, high stability, and low cost.

Deep eutectic solvents (DES) are an emerging class of highly selective CO₂ absorbents. DES are ionic liquids formed by mixing two or more components, typically a hydrogen bond donor (HBD) and a hydrogen bond acceptor (HBA), that can interact to form a eutectic mixture. DES have a melting point that is much lower than individual components, typically remaining a liquid at or near room temperature. A prototypical DES, reline, is a mixture of choline chloride (ChCl) and urea. ChCl is a quaternary ammonium salt, while urea is an organic compound. Reline is thermally stable, non-toxic, biodegradable, and low-cost. The CO₂ absorption capacity of reline is comparable to other CO₂-philic solvents such as ionic liquids and aqueous amines.

DES have properties that offer important advantages as compared to other solvent-based approaches. For example, CO₂ capture with aqueous amines requires significant energy input due to the elevated temperatures required for regeneration and faces solvent loss due to high volatility. Ionic liquids have gained significant attention for CO₂ separation because of negligible vapor pressure, high thermal stability, and low flammability, but their cost, scalability, and toxicity have hindered their commercial deployment. In addition, a disadvantage of DES relative to aqueous amines is the relatively high viscosity of reline and many other DES. In a separation process based on bulk quantities of reline, this viscosity leads to challenges associated with slow absorption/desorption kinetics and energy costs associated with pumping the solvent.

Accordingly, there remains a need for methods for the energy efficient capture of CO₂. In particular, there remains a need for an improved solvent-based, physisorption process for CO₂ separations that is inexpensive and scalable across a range of industries, including the separation of CO₂ from wet flue gases, pre-combustion gases, bio-fuel gases, and other sources, whether now known or hereinafter developed.

### SUMMARY OF THE INVENTION

An improved method for CO₂ separations using a physical solvent is provided. The method includes: (a) contacting the lumen side or the shell side of a plurality of porous hollow fibers with a CO₂-containing gas from a point source; (b) contacting the other of the lumen side or the shell side of the plurality of porous hollow fibers with a liquid phase, the liquid phase including a physical solvent for physisorption of CO₂ into the liquid phase; (c) desorbing the CO₂ from the liquid phase by reducing the pressure of the liquid phase; and (d) recirculating the liquid phase to the plurality of porous hollow fibers. As discussed herein, the improved method provides a modular, scalable process to facilitate gas-liquid contact for CO₂ separations. In addition, the improved method offers significant advantages over existing ionic liquid and amine-based technologies in terms of cost-effectiveness, energy efficiency, process scalability, and environmental stability.

In one embodiment, the physical solvent is a deep eutectic solvent, for example reline (a mixture of choline chloride and urea), ethaline (a mixture of choline chloride and ethylene glycol), or glyceline (a mixture of choline chloride and glycerol). The improved method is not limited to deep eutectic solvents, however, as other physical solvents can include diethyl sebacate. The liquid phase is pressurized to above that of the gas phase to prevent any gas bubble formation at the liquid phase, optionally not more than 1 bar above the pressure of the gas phase. The hollow fibers can include hydrophobic fibers or hydrophilic fibers. Suitable hydrophobic fibers can include, but not limited to, polypropylene (PP), polytetrafluoroethylene (PTFE), polysulfone (PS), or polyvinylidene fluoride (PVDF). The improved method is not limited to any single point source of CO₂. For example, the gas phase can include wet flue gases, pre-combustion gases, CO₂ captured from natural gases such as methane, or CO₂ captured from raw biogas (e.g., biogas upgrading, which includes removing CO₂, water vapor, and hydrogen sulfide from biogas to produce biomethane). To improve the permeate flux, the viscosity of the physical solvent can be reduced, optionally by diluting the physical solvent with water or by heating the physical solvent. For example, the liquid phase can include a mixture of water and a physical solvent with a ratio (wt %) of between 1:1 and 3:1, further optionally 3:2 (i.e., 60% water and 40% physical solvent by weight). In addition, several industrial applications including flue gas streams are typically saturated with water vapor.

In another embodiment, a system for CO₂ separations is provided. The system includes a membrane module, a gas phase containing CO₂, a liquid phase containing a physical solvent, and a solvent reservoir in fluid communication with the membrane module. The membrane module includes a plurality of hollow fibers, the plurality of hollow fibers including a lumen side spaced apart from a shell side to define a membrane therebetween. A first pump directs the gas phase along the lumen side or the shell side of the plurality of hollow fibers, and a second pump directs the liquid phase along the other of the lumen side or the shell side of the plurality of hollow fibers. The membrane separates the gas phase from the liquid phase, the liquid phase being pressurized to slightly above that of the gas phase, optionally between 0.1 bar and 1.0 bar over the pressure of the gas phase. The physical solvent allows for physisorption of the CO₂ into the liquid phase, in contrast to chemisorption, which involves the formation of new chemical compounds. The CO₂ is then desorbed from the liquid phase by reducing the pressure of the liquid phase and/or by heating the liquid phase within the solvent reservoir. Using a second pump, the solvent reservoir utilized for continuously recirculating the liquid phase through the membrane module for scalable, energy efficient CO₂ separations.

These and other features and advantages of the present invention will become apparent from the following description of the invention, when viewed in accordance with the accompanying drawings and appended claims.

### BRIEF DESCRIPTION OF THE DRAWINGS

FIG. 1 illustrates a membrane contactor including porous hollow fibers for CO₂ separation using a physical solvent.

FIG. 2 illustrates a system for CO₂ absorption including the membrane contactor of FIG. 1 using a deep eutectic solvent.

FIG. 3 is an enlarged view of the membrane contactor of FIG. 2 depicting physisorption of CO₂ into a liquid phase containing a deep eutectic solvent.

FIG. 4 illustrates a system for CO₂ absorption including the membrane contactor of FIG. 1 using a diethyl sebacate as a physical solvent.

FIG. 5 is a graph illustrating CO₂ sorption of reline at different temperatures and pressures.

FIG. 6 is a graph illustrating CO₂ absorption and desorption profiles in reline as a function of pressure of the liquid phase.

FIG. 7 is a graph illustrating the flux of gas separated from mixed gases containing CO₂, N₂, and O₂ using reline as a physical solvent.

FIG. 8 is a graph illustrating the purity of CO₂ recovered from a mixture of 50% CO₂ and 50% N₂ using reline as a physical solvent.

FIG. 9 is a graph illustrating CO₂ flux with pure reline and diluted reline at various pressures.

FIG. 10 is a graph illustrating CO₂ flux with a gas phase of pure CO₂ using reline as the physical solvent at various temperatures.

FIG. 11 is a graph illustrating permeate flux using diethyl sebacate as the physical solvent at 1.82 cm/min solvent linear velocity (solvent volumetric flow rate: 182 mL/min) for a gas phase of 50% CO₂ and 50% N₂ at various pressures.

FIG. 12 is a graph illustrating permeate flux using diethyl sebacate as the physical solvent at 4 bar, 2.75 cm/min solvent linear velocity (solvent volumetric flow rate: 275 mL/min) for a gas phase of 50% CO₂ and 50% N₂ at various temperatures.

FIG. 13 is a graph illustrating the effect of water concentration in reline on permeate flux at 35° C. and 4 bar for different feed compositions.

FIG. 14 is a graph illustrating the effect of water concentration in solve (water-reline mixture) on permeate flux and CO₂ purity.

### DETAILED DESCRIPTION OF THE CURRENT EMBODIMENTS

As discussed herein, the current embodiments include a method for CO₂ separations using a physical solvent. The method generally includes: (a) contacting the lumen side or the shell side of a plurality of porous hollow fibers with a CO₂-containing gas; (b) contacting the other of the lumen side or the shell side of the plurality of porous hollow fibers with a liquid phase, the liquid phase including a physical solvent for physisorption of CO₂; (c) desorbing the CO₂ from the liquid phase by reducing the pressure of the liquid phase; and (d) recirculating the liquid phase to the plurality of porous hollow fibers. Each step of the foregoing method is separately discussed below.

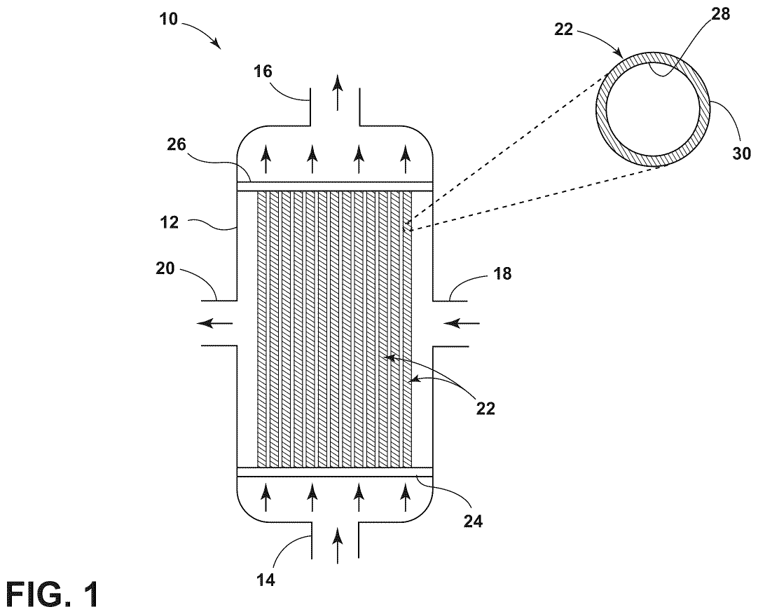

Before the aforementioned steps are discussed in detail, an exemplary membrane module is illustrated in FIG. 1 and generally designated 10. The membrane module 10 includes an outer casing 12 defining a first input port 14, a first output port 16, a second input port 18, and a second output port 20. A plurality of porous hollow fibers 22 are potted to first and second tubesheets 24, 26 at opposing ends thereof, such that the fibers 22 extend in a common direction within the module 10. Each fiber 22 includes a lumen side 28 and a shell side 30. As used herein, the “lumen side” includes the interior surface that defines a channel extending through the length of the hollow fiber, and the “shell side” includes the exterior surface of the fiber, such that the lumen side and the shell side are spaced apart from each other by the thickness of the membrane sidewall. In one embodiment, the lumen side 28 is exposed to the liquid phase and the shell side 30 is exposed to the gas phase. In other embodiments however, the lumen side 28 is exposed to the gas phase and the shell side 30 is exposed to the liquid phase.

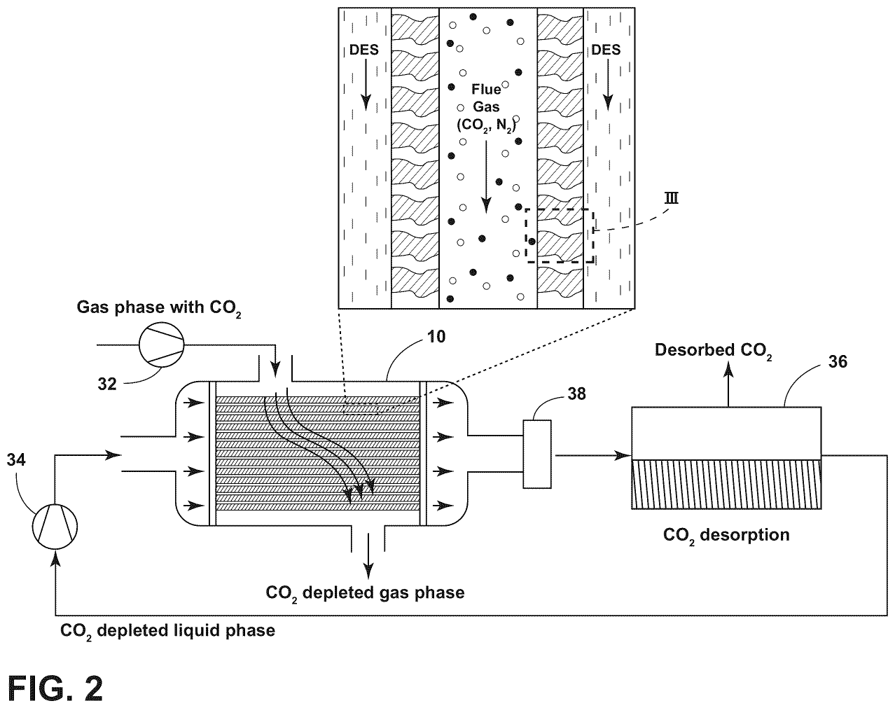

Referring again to the present method, a first step includes directing the gas phase along a lumen side or a shell side of the plurality of porous hollow fibers 22. As shown in FIG. 2, for example, the gas phase is directed along the shell side 30 of the plurality of hollow fibers 22. As noted above, however, the gas phase can instead be directed along the lumen side 28 of the plurality of hollow fibers 22. The gas phase can originate from a point source, for example wet flue gases comprising CO₂ and N₂. The present invention is not limited to any single point source of CO₂, however. For example, the gas phase can include pre-combustion gases, CO₂ captured from hydrogen gas, CO₂ captured from natural gases such as methane, or CO₂ captured from raw biogas (e.g., biogas upgrading, which includes removing CO₂, water vapor, and hydrogen sulfide from biogas to produce biomethane).

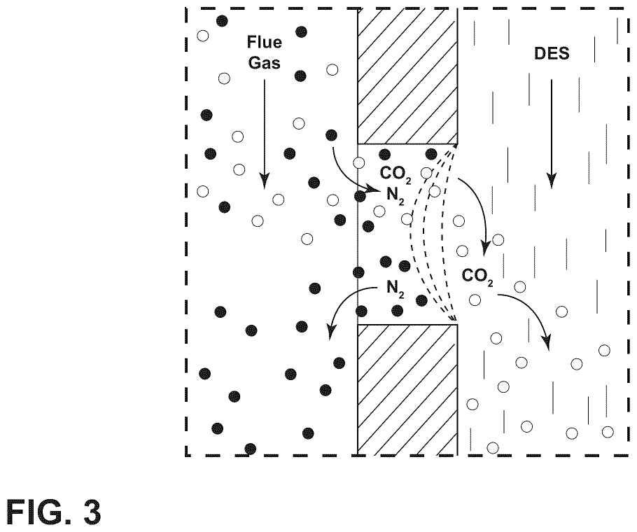

Simultaneously with the first step, the method includes directing the liquid phase along the other of the lumen side or the shell side of the plurality of porous hollow fibers. As shown in FIG. 2, for example, the liquid phase is directed along the lumen side 28 of the plurality of hollow fibers 22. The liquid phase includes a physical solvent for the physisorption of CO₂ from the gas phase, predominately at the surface of the hollow fibers in contact with the liquid phase, generally depicted in FIG. 3. As used herein, the term “physical solvent” means any solvent that absorbs a gas without chemical reactions. In contrast to chemisorption, for example, a physical solvent absorbs a gas via physisorption. Physisorption is a process by which gas molecules adhere to a solvent through weak van der Waals forces. These forces are much weaker than chemical bonds and do not involve the formation of new chemical compounds. Advantageously, physisorption is generally reversible because the interactions are weak, thus allowing for desorption of CO₂ via depressurization or heating of the liquid phase, as discussed below.

In the embodiment of FIGS. 2-3, the physical solvent includes a deep eutectic solvent (DES). As noted above, DES includes a mixture of a hydrogen bond donor and a hydrogen bond acceptor. Examples include, but are not limited to, reline (ChCl and urea), ethaline (ChCl and ethylene glycol), and glyceline (ChCl and glycerol). Other DES physical solvents can be used in other embodiments and are not limited to the foregoing.

The plurality of hollow fibers can be selected based on the physical solvent and based on other process parameters, such as the pressure differential. In some embodiments, the plurality of hollow fibers are hydrophobic (i.e., repelling water and not readily absorbing moisture), while in other embodiments the hollow fibers are hydrophilic (i.e., having an affinity for water). Suitable hydrophobic fibers can include, by non-limiting example, polypropylene (PP), polytetrafluoroethylene (PTFE), polysulfone (PS), or polyvinylidene fluoride (PVDF). The porous hollow fibers can include a pore size of between 1.0 nm to 100 nm. Small pore sizes help prevent any leakage of the physical solvent across the membrane by wetting of the surface due to hydrophobicity of the porous hollow fibers. In addition, the porous hollow fibers can include an inner diameter of between 0.1 mm and 1 mm and an outer diameter of between 0.2 mm and 1 mm. Still other pore sizes and inner and outer diameters can be used in other embodiments as desired.

As noted above, the gas phase and the liquid phase are simultaneously moved through the membrane module 10, generally in a cross-flow configuration. The liquid phase is pressurized to be slightly greater than the gas phase. For example, the gas phase can be pressurized to 4 bar, and the liquid phase can be pressurized to 4.5 bar. More specifically, a gas pump 32 compresses the gas phase to a first pressure, and a liquid pump 34 compresses the liquid phase to a second pressure, the second pressure being greater than the first pressure. The method then includes desorbing the CO₂ from the liquid phase, downstream of the membrane module 10. This can be achieved by reducing the pressure of the liquid phase at a solvent reservoir 36, optionally via a variable valve 38. For example, CO₂ can be desorbed from the physical solvent at lower pressure, optionally atmospheric pressure. Alternatively, or additionally, desorption can be achieved by heating the liquid phase in the solvent reservoir 36. The CO₂-depleted liquid phase is recirculated to the membrane module 10 using the pump 34 to continue the separation process.

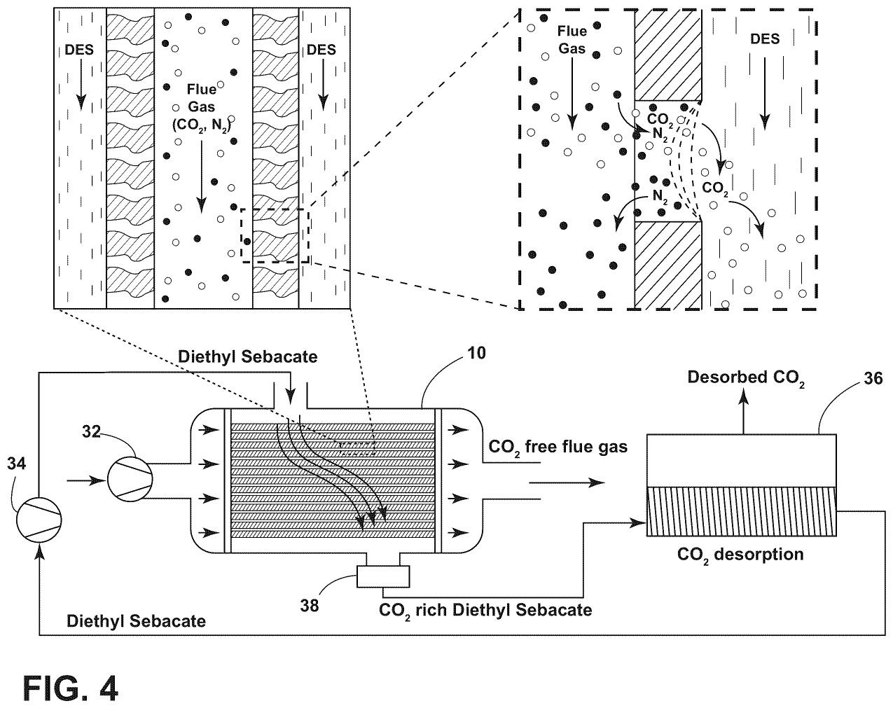

In still other embodiments, the physical solvent does not include a DES. For example, the physical solvent can include diethyl sebacate (not to be confused with DES, which as used herein refers to a deep eutectic solvent). Diethyl sebacate is an organic compound that consists of two ethyl groups attached to a sebacic acid molecule. Diethyl sebacate is colorless and is soluble in organic solvents, with limited solubility in water. A laboratory example including diethyl sebacate as a physical solvent is discussed in Example 2 below, achieving a purity of 95.3% of CO₂ with the present method. This embodiment is generally shown in FIG. 4, which depicts the physical solvent (diethyl sebacate) as being directed along the shell side of the plurality of fibers, with the gas phase (wet flue gases) being directed along the lumen side of the plurality of fibers.

To reiterate, the present method provides a scalable, energy-efficient membrane contactor-based process for highly efficient CO₂ capture using a physical solvent, for example a deep eutectic solvent such as reline, ethaline, glyceline, or diethyl sebacate. In the laboratory examples below, the present inventors demonstrated the removal of CO₂ with a purity of greater than 95% from a mixture of CO₂ and N₂, optionally containing water vapor as described herein. The CO₂ flux increased linearly with the feed pressure, and the viscosity of the liquid phase can be reduced by adding water or by slightly increasing the temperature of the liquid phase. Laboratory measurements also confirmed that separation occurs via a physisorption mechanism without any new compound formation. The foregoing method offers significant advantages over existing ionic liquid and amine-based technologies in terms of cost-effectiveness, energy efficiency, continuous operation (as opposed to equilibrium-limited batch operations), process scalability, and environmental stability.

The Following Laboratory Examples are Non-Limiting and Depict Various Embodiments of the Instant Method for the Absorption of CO₂ from a Point Source.

### Example 1

In a first example, reline was synthesized by drying choline chloride and urea precursors for 24 hours. After drying, the choline chloride and urea were mixed together with a molar ratio of 1:2. The resulting solid mixture was heated at 70° C. under stirring for about 2 hours until all the solids were liquified. The liquid reline was passed through the lumen side of a microporous polypropylene hollow fiber membrane module from 3M. The surface area of the membrane module (3M Liqui-Cel contactor) was 1.4 m², with about 10,000 fibers housed in a cylindrical module 66 mm in diameter and 256 mm in height. The gas phase was passed through the shell side of the membrane, on the outside of the hollow fibers. The temperature of the liquid reline was maintained at about 35° C. The gas pressure was varied from 0 bar to 4 bar. Typically, the liquid pressure was kept at 0.3 bar higher than the gas pressure to prevent any gas bubble formation at the liquid phase. A gear pump was used to transfer 350 mL of reline from a 500 mL reservoir to the membrane module. A variable valve at the outlet of the lumen side of the membrane module was used to control the pressure at the liquid phase. The pressures of the gas phase and the liquid phase were increased simultaneously until the system reached a steady state.

When the CO₂-loaded liquid phase exited the membrane module, the CO₂ was desorbed from the liquid phase at lower pressure (atmospheric pressure) in a solvent reservoir. The CO₂-depleted liquid phase was then recirculated to the membrane module using the gear pump to continue the separation. The permeate flux was then measured using a bubble flow meter. During separation of CO₂ from mixed gases containing CO₂, N₂, and O₂, the composition of the permeate gas was determined using gas chromatography (Model: Agilent Technologies GC 7820A) with a thermal conductivity detector (TCD) and a GS-CarbonPlot column to distinguish CO₂ from N₂ and O₂.

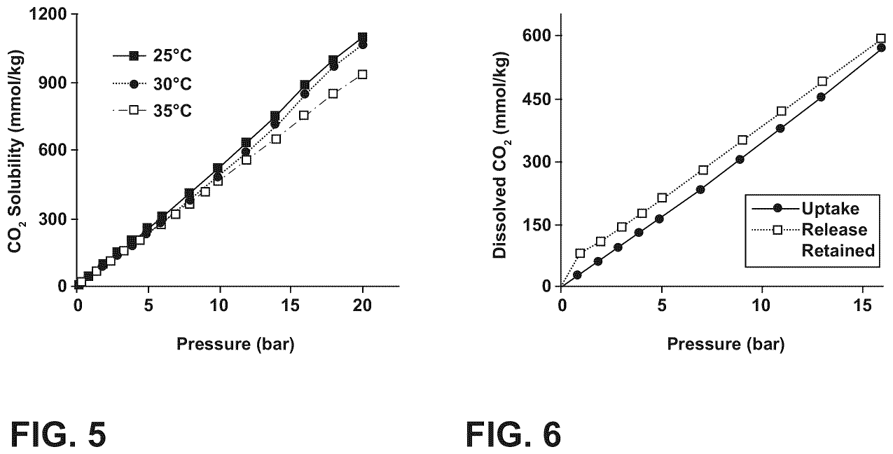

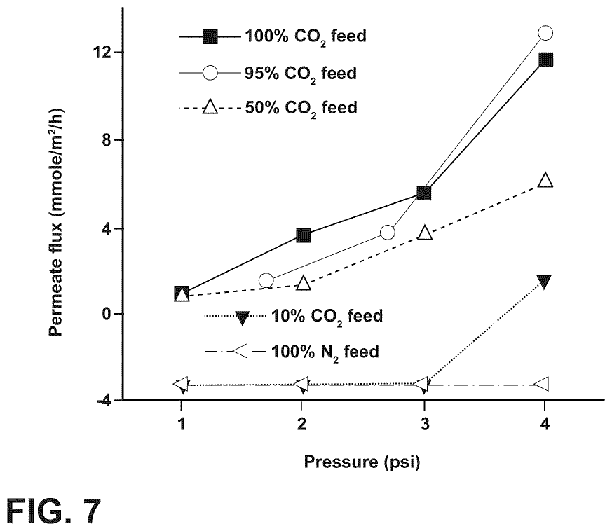

As shown in FIG. 5, the gas solubility of CO₂ was measured at 25° C., 30° C. and 35° C. at pressures up to 20 bar. The gas solubility increased linearly to almost 1,200 mmol/kg at 20 bar. To determine whether CO₂ was fully desorbed from the liquid phase once the applied pressure was released, samples were charged with CO₂ at high pressure and then pressure was reduced. The obtained absorption and desorption isotherms of CO₂ in reline are shown in FIG. 6, exhibiting some hysteresis between CO₂ solubility during uptake and pressure release. The above method was also evaluated for various gas mixtures. Three gas mixtures with CO₂ compositions of 10 mol %, 50 mol %, and 95 mol % were used as the feed gas, with pure CO₂ and pure N₂ as baselines. The effect of the CO₂ composition in the feed gas is shown in FIG. 7, demonstrating versatility for CO₂ capture from various point sources of CO₂. The applied pressure was increased up to 4 bar at the gas phase, with a pressure differential of 0.3 bar (i.e., the overpressure at the liquid phase). When the feed mixture was 95 mol % CO₂, the permeate gas flux was similar to results for pure CO₂. When the feed mixture contained only 10 mol % CO₂, no permeate gas flux was observed until the applied pressure was at least 4 bar. The maximum permeate flux with the feed gas containing 50 mol % CO₂ was 6.1 mmol/m²/h.

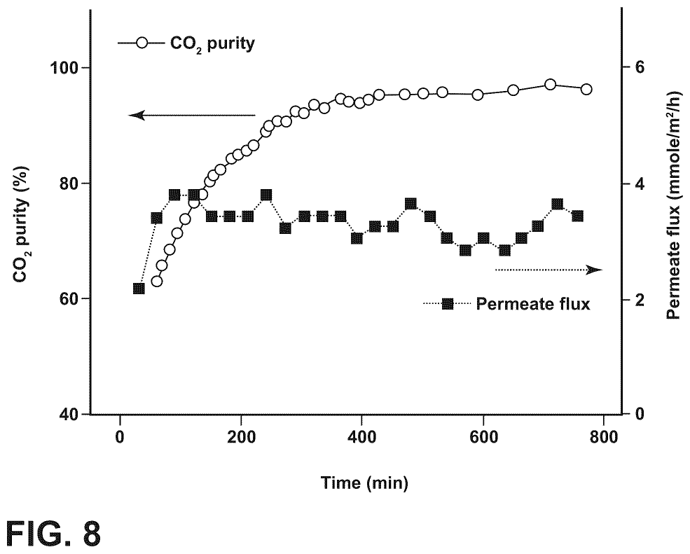

The permeate gas was then analyzed using gas chromatography to determine the CO₂ purity in the permeate gas recovered from a feed gas that was 50 mol % CO₂ and 50 mol % N₂. The gas pressure was maintained at 3 bar, and the temperature of the liquid phase was 35° C. The permeate composition as a function of time is shown in FIG. 8. The purity of CO₂ in the permeate gas increased with time because the permeate gas displaced the air from the solvent reservoir and the tubing leading to the gas chromatography instrument. After 7 hours, the purity of CO₂ in the permeate was 95.1 mol %. After an additional 6 hours, the purity of CO₂ increased to 96.9 mol %. During the 13-hour continuous run, no liquid transferred from the lumen side to the shell side of the membrane module. During this period, reline flowed through the membrane module for more than 50 cycles of absorption and desorption. In this cycling, no significant change in the permeate was observed, indicating that the process was indeed stable.

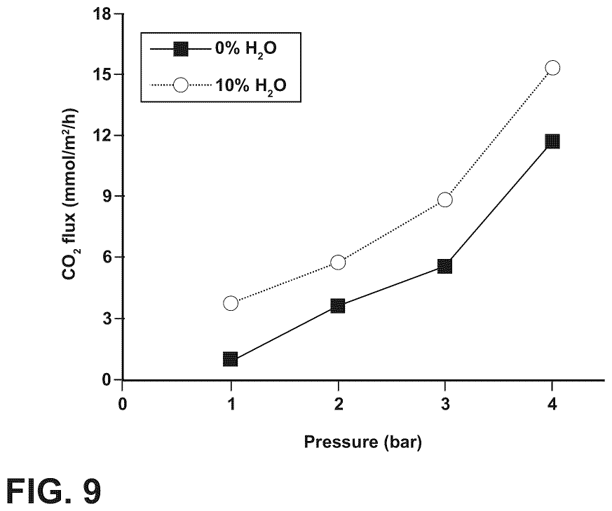

The effect of water in reline on the CO₂ separation was also evaluated. Experiments were performed on the effect of water in reline on the CO₂ separation process using reline with 10 wt. % water at 35° C. using pure CO₂ as the feed gas. As shown in FIG. 9, reline with 10 wt. % water exhibited higher CO₂ flux than pure reline under the same process conditions. In the membrane module, adding water to reline increased the observed CO₂ flux by about 30%. This observation indicates that the enhanced CO₂ flux is due to the lower viscosity of the reline-water mixture compared with pure reline.

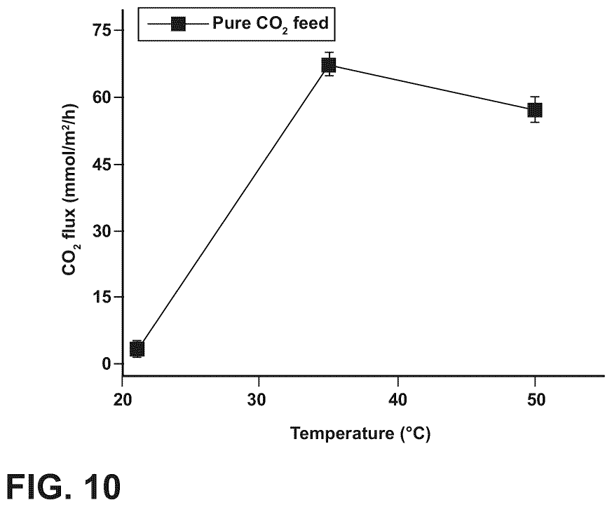

Lastly, the effect of temperature of the liquid phase was also studied using reline with 10 wt. % water at 35° C. using pure CO₂ as the feed gas. The temperature was varied from 21° C. to 50° C. The CO₂ permeate flux at varying temperatures is shown in FIG. 10. The permeate flux increased with temperature from 21° C. to 35° C. However, the permeate flux decreased slightly at 50° C. At that temperature, the solubility effect dominated over the kinetic effect on the permeate flux.

### Example 2

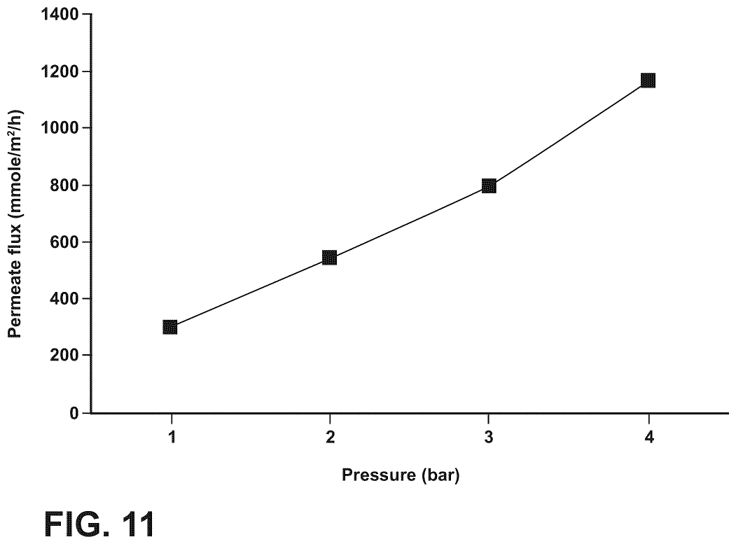

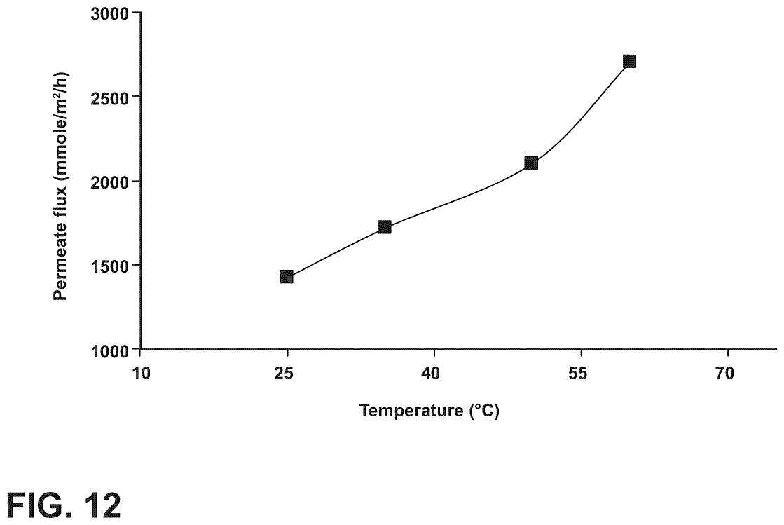

In a second example, diethyl sebacate was evaluated as a physical solvent for the separation of CO₂ from N₂. Using a PVDF membrane module with a 0.1 m² surface area from Arkema, the gas phase (50% CO₂, 50% N₂) was fed into the lumen side of the module. Simultaneously, the liquid phase (diethyl sebacate, >98% purity from Tokyo Chemical Industry Co.) was fed into the shell side of the module with a slight overpressure relative to the pressure of the gas phase. The permeate flux is illustrated in FIG. 11 for pressures (liquid phase) at 1 bar, 2 bar, 3 bar, and 4 bar. As the pressure increased, the permeate flux increased, demonstrating a positive correlation. At each pressure, the gas phase was kept at about 5 psi lower than the liquid phase to combat the hydrophobic-hydrophobic interactions at the membrane surface that allow for solvent to push through the pores of the membrane. The solvent flow rate was tested from 25 mL/min to 350 mL/min in increments of 25 mL/min. A solvent flow rate of 275 mL/min was the optimal flow rate, achieving a maximum permeate flux of about 1,500 mmol/m²/h. The flow rate directly affected the time the solvent was in the membrane module, and thus indirectly effected the permeate flux and the overall separation of CO₂. The temperature effect on viscosity was also investigated. The results are depicted in FIG. 12. An increase in temperature of the liquid phase had an indirect effect on the permeate flux, as viscosity directly impacts the permeate flux (the rate at which the permeate is produced) as a result of improved mass transfer. Therefore, viscosity decreases and thereby increases the CO₂ permeate flux. With a less viscous solvent, there is more opportunity for separation due to lower resistance and shear stress. However, heating the liquid phase requires additional energy to maintain elevated temperatures, and should thus be balanced against the increase in permeate flux.

### Example 3

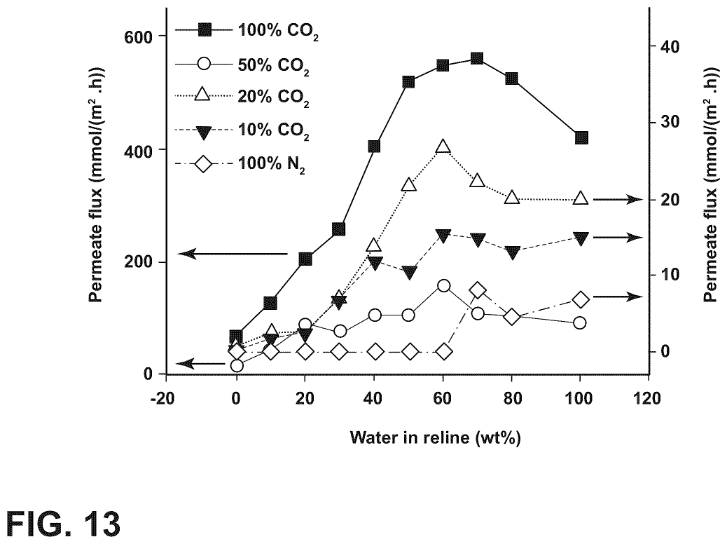

A third example explored the effect of different solvent concentrations on permeate flux. For this example, the gas phase was maintained at 35° C. and 4 bar. For all CO₂ concentrations in the gas phase, the permeate flux showed an increasing trend and then decreased when approximately 60 wt % water was present in the liquid phase. The results are depicted FIG. 13. For the sample with 60 wt % water in the liquid phase, a permeate flux of 170 mmol/(m²·h) was observed, which was approximately eight (8) times higher than that of pure reline for a 50 mol % CO₂ feed. This result indicates that water in reline helps significantly in improving the CO₂ removal in a continuous membrane contactor process. This assistance is attributed to the reduced viscosity of the liquid phase, which improves the CO₂ removal kinetics and thus improves permeate flux. This behavior was consistent for all compositions of CO₂ in the feed gas. However, with further increases of water concentration in reline >60 wt %, a reduction in permeate flux was observed. This reduction can be attributed to the unavailability of enough reline in the water-reline mixture to effectively capture CO₂.

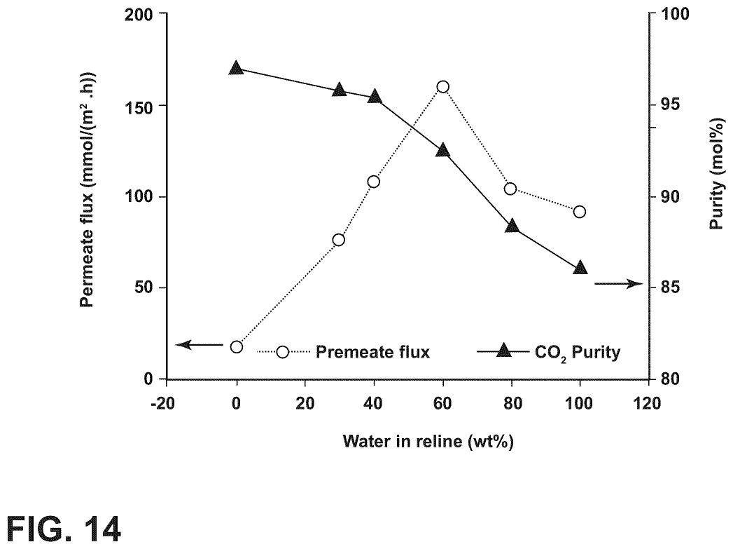

The effect of water concentration in the liquid phase on permeate flux and CO₂ purity is depicted in FIG. 14. The permeate gas was analyzed using gas chromatography to determine the CO₂ purity in the permeate gas recovered from a feed gas that was 50 mol % CO₂ and 50 mol % N₂. The gas pressure was maintained at 4 bar, and the temperature of the water-reline mixture was maintained at 35° C. FIG. 14 shows that with the increase in water concentration in the liquid phase, permeate flux first increases and then beings decreasing at approximately 60 wt % water. Therefore, 60 wt % water in solvent is considered an optimum solvent concentration because it maintains >90% CO₂ purity with a reasonably high permeate flux. The decline in permeate flux beyond 60 wt % water can be attributed to a higher amount of water in the liquid phase, which does not contribute to CO₂ absorption. Moreover, CO₂ purity in the permeate continuously decreased with an increase in the water concentration in the solvent. While pure reline separated CO₂ with a purity of 97%, solvent with water showed reduced CO₂ purity in the permeate gas. A continuous reduction in CO₂ purity at higher water concentrations is likely due to the lesser amount of reline, which is responsible for selectively absorbing CO₂.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A method comprising:
providing a membrane module including a plurality of hollow fibers, the plurality of hollow fibers including a lumen side spaced apart from a shell side to define a membrane therebetween, the membrane including a plurality of pores dispersed therein;
contacting the lumen side or the shell side of the plurality of hollow fibers with a gas phase, wherein the gas phase includes CO₂;
contacting the other of the lumen side or the shell side of the plurality of hollow fibers with a liquid phase, wherein the liquid phase includes a physical solvent for physisorption of CO₂ into the liquid phase;
desorbing CO₂ from the liquid phase by reducing a pressure of the liquid phase or by heating the liquid phase downstream of the membrane module; and
after desorbing CO₂ from the liquid phase, recirculating the liquid phase to the membrane module for the continuous physisorption of CO₂ into the liquid phase.

2. The method according to claim 1, wherein the liquid phase is pressurized to a greater extent than the gas phase, such that a pressure differential exists therebetween.

3. The method according to claim 1, wherein the physical solvent is a deep eutectic solvent.

4. The method according to claim 3, wherein the deep eutectic solvent includes reline, ethaline, or glyceline.

5. The method according to claim 1, wherein the gas phase contacts the lumen side and the liquid phase contacts the shell side.

6. The method according to claim 1, wherein the liquid phase contacts the lumen side and the gas phase contacts the shell side.

7. The method according to claim 1, wherein the membrane includes a pore size of between 20 nm to 100 nm.

8. The method according to claim 1, wherein the plurality of hollow fibers define an inner diameter of between 0.1 mm and 1 mm.

9. The method according to claim 1, wherein the plurality of hollow fibers define an outer diameter of between 0.1 mm and 1 mm.

10. The method according to claim 1, wherein the plurality of hollow fibers are hydrophobic fibers.

11. The method according to claim 10, wherein the hydrophobic fibers include polypropylene (PP), polytetrafluoroethylene (PTFE), polysulfone (PS), or polyvinylidene fluoride (PVDF).

12. The method according to claim 1, wherein the gas phase includes wet flue gases containing CO₂.

13. The method according to claim 1, wherein the physical solvent includes diethyl sebacate.

14. The method according to claim 1, wherein the liquid phase includes a mixture of water and a deep eutectic solvent with a ratio (wt %) of between 1:1 and 3:1, inclusive.

15. A system for CO₂ separations, the system comprising:
a membrane module including a plurality of hollow fibers, the plurality of hollow fibers including a lumen side spaced apart from a shell side to define a membrane therebetween, the membrane including a plurality of pores dispersed therein;
a first pump for directing a flow rate of a gas phase along the lumen side or the shell side of the plurality of hollow fibers, wherein the gas phase includes CO₂;
a second pump for directing a flow rate of a liquid phase along the other of the lumen side or the shell side of the plurality of hollow fibers, wherein the membrane separates the gas phase from the liquid phase, and wherein the liquid phase includes a physical solvent for physisorption of the CO₂ into the liquid phase; and
a solvent reservoir downstream of the membrane module for desorbing the CO₂ from the liquid phase, wherein the second pump provides recirculation of the solvent reservoir through the membrane module.

16. The system of claim 15, wherein the liquid phase is pressurized to a greater extent than the gas phase, such that a pressure differential exists therebetween.

17. The system of claim 15, wherein the physical solvent includes reline, ethaline, glyceline, or diethyl sebacate.

18. The system of claim 15, wherein the plurality of hollow fibers are hydrophobic fibers.

19. The system of claim 18, wherein the hydrophobic fibers include polypropylene, polytetrafluoroethylene, polysulfone, or polyvinylidene fluoride.

20. The system of claim 15, wherein the liquid phase includes a mixture of water and a deep eutectic solvent with a ratio (wt %) of between 1:1 and 3:1, inclusive.

21. The system of claim 15, wherein the physical solvent is a pure physical solvent, such that the liquid phase does not include a diluting component.
